(19) United States
(12) Patent Application Publication
(10) Pub. No.: US 2024/0178539 A1
(43) Pub. Date: May 30, 2024

(54) WAVEGUIDE DEVICE AND METHOD OF PRODUCING WAVEGUIDE DEVICE

(71) Applicant: NGK INSULATORS, LTD., Nagoya-City (JP)

(72) Inventors: Kentaro TANI, Nagoya-Shi (JP); Naotake OKADA, Anjo-Shi (JP); Jungo KONDO, Miyoshi-Shi (JP)

(73) Assignee: NGK INSULATORS, LTD., Nagoya-City (JP)

(21) Appl. No.: 18/433,534

(22) Filed: Feb. 6, 2024

Related U.S. Application Data
(63) Continuation of application No. PCT/JP2022/029940, filed on Aug. 4, 2022.

(30) Foreign Application Priority Data
Aug. 12, 2021 (JP) 2021-131757
Dec. 20, 2021 (JP) 2021-206456
Dec. 20, 2021 (JP) 2021-206457

(51) Int. Cl. H01P 3/00; H01P 11/00

(52) U.S. Cl. CPC H01P 3/006; H01P 11/003

(57) ABSTRACT

A waveguide device includes: an inorganic material substrate; a conductor layer including a signal electrode and first earth electrodes; a support substrate positioned on an opposite side to the conductor layer with respect to the inorganic material substrate; a second earth electrode positioned between the inorganic material substrate and the support substrate; and a third earth electrode positioned on an opposite side to the second earth electrode with respect to the support substrate. The first earth electrodes, the second earth electrode, and the third earth electrode are electrically connected to each other. A thickness “t” of the inorganic material substrate satisfies the following formula (1).

$$t < \frac{λ}{a \sqrt{ε}} \qquad ( 1 )$$

### CROSS-REFERENCE TO RELATED APPLICATIONS

This application is a continuation under 35 U.S.C. 120 of International Application PCT/JP2022/029940 having the International Filing Date of 4 Aug. 2022 and having the benefit of the earlier filing dates of Japanese Application No. 2021-131757 filed on 12 Aug. 2021, Japanese Application No. 2021-206456 filed on 20 Dec. 2021, and Japanese Application No. 2021-206457 filed on 20 Dec. 2021. Each of the identified applications is fully incorporated herein by reference.

### BACKGROUND OF THE INVENTION

### 1. Field of the Invention

The present invention relates to a waveguide device and a method of producing a waveguide device.

### 2. Description of the Related Art

A waveguide device is being developed as a device for guiding waves ranging from a millimeter wave to a terahertz wave. The waveguide device is expected to be applied and rolled out in a wide range of fields, such as optical waveguides, next-generation high-speed communication, sensors, laser processing, and solar power generation. As an example of such waveguide device, there is a proposal of a technology involving using a grounded coplanar waveguide including: a glass substrate having a thickness of 300 μm; a coplanar conductor arranged on the glass substrate; and a ground electrode arranged on a surface of the glass substrate on an opposite side to the coplanar conductor (Patent Literature 1).

When a waveguide device based on such technology is adopted in various industrial products, the mounting of the waveguide device on a support substrate, such as an IC substrate or a printed circuit board, is considered. However, when the waveguide device is mounted on the support substrate to guide waves ranging from a millimeter wave to a terahertz wave (in particular, an electromagnetic wave having a frequency of 300 GHz or more), there is a problem in that a propagation loss significantly increases.

### CITATION LIST

### Patent Literature

[PTL 1] JP 2021-509767 A

### SUMMARY OF THE INVENTION

A primary object of the present invention is to provide a waveguide device, which can sufficiently reduce a propagation loss even when a high-frequency electromagnetic wave having a frequency of 30 GHz or more is guided, and a method of producing the device.
[1] According to an embodiment of the present invention, there is provided a waveguide device capable of guiding an electromagnetic wave having a frequency of 30 GHz or more and 20 THz or less. The waveguide device includes: an inorganic material substrate; a conductor layer arranged above the inorganic material substrate, the conductor layer including a signal electrode extending in a predetermined direction, and first earth electrodes each arranged in a direction intersecting the predetermined direction at a distance from the signal electrode; a support substrate positioned on an opposite side to the conductor layer with respect to the inorganic material substrate; a second earth electrode positioned between the inorganic material substrate and the support substrate; and a third earth electrode positioned on an opposite side to the second earth electrode with respect to the support substrate. The first earth electrodes, the second earth electrode, and the third earth electrode are electrically connected to each other. A thickness “t” of the inorganic material substrate satisfies the following formula (1):

$$t < \frac{λ}{a \sqrt{ε}} \qquad ( 1 )$$

where “t” represents the thickness of the inorganic material substrate, A represents a wavelength of an electromagnetic wave guided by the waveguide device, ε represents a relative dielectric constant of the inorganic material substrate at 300 GHz, and “a” represents a numerical value of 3 or more.
[2] The waveguide device according to the above-mentioned item [1] may further include a first via. The first via is configured to electrically connect each of the first earth electrodes and the third earth electrode to each other, and is electrically connected to the second earth electrode.
[3] The waveguide device according to the above-mentioned item [2] may further include a first via hole. The first via is arranged in the first via hole. The first via hole penetrates through the inorganic material substrate, the second earth electrode, and the support substrate.
[4] In the waveguide device according to the above-mentioned item [3], the first via hole has a circular shape when viewed from a front surface (upper surface) direction of the inorganic material substrate, and has such a tapered shape that a diameter thereof becomes smaller as a distance thereof from the second earth electrode becomes shorter.
[5] In the waveguide device according to the above-mentioned item [3], the first via hole has a circular shape when viewed from a front surface (upper surface) direction of the inorganic material substrate, and may have such a tapered shape that a diameter thereof becomes larger as a distance thereof from the second earth electrode becomes shorter.
[6] The waveguide device according to any one of the above-mentioned items [2] to [5] may further include a second via. The second via is configured to electrically connect each of the first earth electrodes and the second earth electrode to each other. The waveguide device may include the plurality of first vias. The second via is arranged between the first vias adjacent to each other out of the plurality of first vias.
[7] The waveguide device according to the above-mentioned item [6] may further include a second via hole. The second via is arranged in the second via hole. The second via hole penetrates through the inorganic material substrate and is free from penetrating through the support substrate.
[8] The waveguide device according to the above-mentioned item [1] may further include a second via and a third via. The second via is configured to electrically connect each of the first earth electrodes and the second earth electrode to each other. The third via is configured to electrically connect the second earth electrode and the third earth electrode to each other.
[9] In the waveguide device according to any one of the above-mentioned items [1] to [8], “a” in the formula (1) may represent a numerical value of 6 or more.
[10] In the waveguide device according to any one of the above-mentioned items [1] to [9], the inorganic material substrate may have a relative dielectric constant ε of 3.5 or more and 12.0 or less, and a dielectric loss tangent (dielectric loss) tanδ of 0.003 or less at 300 GHz.
[11] In the waveguide device according to the above-mentioned item [10], the inorganic material substrate may be a quartz glass substrate.
[12] In the waveguide device according to any one of the above-mentioned items [1] to [11], the conductor layer may be coplanar electrodes.
[13] In the waveguide device according to any one of the above-mentioned items [1] to [11], the conductor layer and the second earth electrode may be microstrip electrodes.
[14] In the waveguide device according to the above-mentioned item [12] or [13], when the electromagnetic wave propagating in the waveguide device has a frequency of 30 GHz or more and 5 THz or less, the inorganic material substrate may have a thickness of 10 μm or more.
[15] According to another aspect of the present invention, there is provided a method of producing the waveguide device of any one of the above-mentioned items [2] to [5], including the steps of: preparing a laminate including the inorganic material substrate, the second earth electrode, and the support substrate in the stated order, the laminate having a first via hole collectively penetrating through the inorganic material substrate, the second earth electrode, and the support substrate; and forming the first via in the first via hole, forming the third earth electrode below the support substrate, and forming the conductor layer above the inorganic material substrate.
[16] According to another aspect of the present invention, there is provided a method of producing the waveguide device of the above-mentioned item [6], including the steps of: preparing a laminate including the inorganic material substrate, the second earth electrode, and the support substrate in the stated order, the laminate having a first via hole collectively penetrating through the inorganic material substrate, the second earth electrode, and the support substrate, and a second via hole penetrating through the inorganic material substrate and being free from penetrating through the support substrate (the second via hole penetrating through only the inorganic material substrate); and forming the first via in the first via hole, forming the second via in the second via hole, forming the third earth electrode below the support substrate, and forming the conductor layer above the inorganic material substrate.
[17] According to another embodiment of the present invention, there is provided a waveguide device capable of guiding an electromagnetic wave having a frequency of 30 GHz or more and 20 THz or less. The waveguide device includes: an inorganic material substrate; a conductor layer arranged above the inorganic material substrate, the conductor layer including a signal electrode extending in a predetermined direction, and first earth electrodes each arranged in a direction intersecting the predetermined direction at a distance from the signal electrode; a support substrate positioned on an opposite side to the conductor layer with respect to the inorganic material substrate; a second earth electrode positioned between the inorganic material substrate and the support substrate; a third earth electrode positioned on an opposite side to the second earth electrode with respect to the support substrate; and a via, which is configured to electrically connect each of the first earth electrodes and the third earth electrode to each other, and is electrically connected to the second earth electrode. A thickness “t” of the inorganic material substrate satisfies the formula (1).
[18] According to still another embodiment of the present invention, there is provided a waveguide device capable of guiding an electromagnetic wave having a frequency of 30 GHz or more and 20 THz or less. The waveguide device includes: an inorganic material substrate; a conductor layer arranged above the inorganic material substrate, the conductor layer including a signal electrode extending in a predetermined direction, and first earth electrodes each arranged in a direction intersecting the predetermined direction at a distance from the signal electrode; a support substrate positioned on an opposite side to the conductor layer with respect to the inorganic material substrate; a second earth electrode positioned between the inorganic material substrate and the support substrate; a third earth electrode positioned on an opposite side to the second earth electrode with respect to the support substrate; a first via, which is configured to electrically connect each of the first earth electrodes and the third earth electrode to each other, and is electrically connected to the second earth electrode; and a second via configured to electrically connect each of the first earth electrodes and the second earth electrode to each other. The waveguide device includes the plurality of first vias, and the second via is arranged between the first vias adjacent to each other out of the plurality of first vias. A thickness “t” of the inorganic material substrate satisfies the formula (1).

According to the embodiment of the present invention, the waveguide device, which can sufficiently reduce a propagation loss even when a high-frequency electromagnetic wave having a frequency of 30 GHz or more is guided, can be achieved. In addition, according to the embodiment according to the other aspect of the present invention, the above-mentioned waveguide device can be smoothly produced.

### BRIEF DESCRIPTION OF THE DRAWINGS

FIG. 1 is a schematic perspective view of a waveguide device according to an embodiment of the present invention.

FIG. 2 is a cross-sectional view of the waveguide device taken along the line II-II′ of FIG. 1.

FIG. 3 is a cross-sectional view of a waveguide device according to another embodiment of the present invention taken along the line II-II′.

FIG. 4 is a cross-sectional view of the waveguide device according to the other embodiment of the present invention taken along the line IV-IV′.

FIG. 5 is a cross-sectional view of a waveguide device according to still another embodiment of the present invention taken along the line II-II′.

FIG. 6 is a cross-sectional view of a waveguide device according to still another embodiment of the present invention taken along the line II-II′.

FIG. 7 is a schematic perspective view of a waveguide device according to still another embodiment of the present invention.

FIG. 8 is a cross-sectional view of the waveguide device taken along the line VIII-VIII′ of FIG. 7.

FIG. 9 is a cross-sectional view of the waveguide device taken along the line IX-IX′ of FIG. 7.

FIG. 10 is a cross-sectional view of the waveguide device taken along the line X-X′ of FIG. 7.

FIG. 11 is a cross-sectional view of a waveguide device according to still another embodiment of the present invention taken along the line X-X′.

FIG. 12 is a cross-sectional view of a waveguide device according to still another embodiment of the present invention taken along the line X-X′.

FIG. 13 is a cross-sectional view of a waveguide device according to still another embodiment of the present invention taken along the line VIII-VIII′.

FIG. 14 is a cross-sectional view of a waveguide device according to still another embodiment of the present invention taken along the line X-X′.

### DESCRIPTION OF THE EMBODIMENTS

Embodiments of the present invention are described below. However, the present invention is not limited to these embodiments.

### A. Overall Configuration of Waveguide Device

### A-1. Overall Configuration of Waveguide Device 100

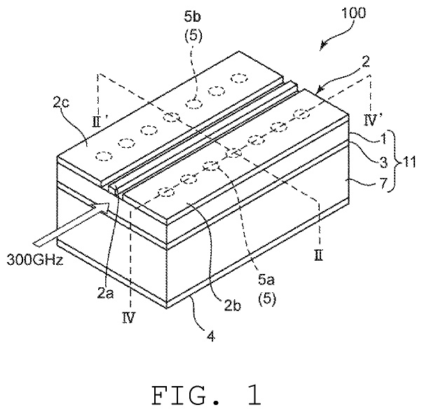

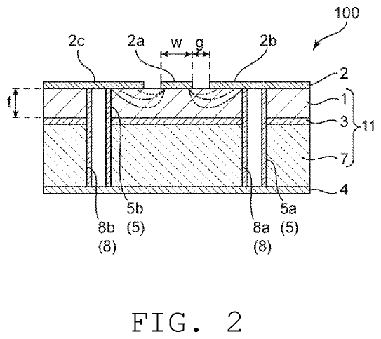

FIG. 1 is a schematic perspective view of a waveguide device according to one embodiment of the present invention, and FIG. 2 is a cross-sectional view of the waveguide device taken along the line II-II′ of FIG. 1.

A waveguide device 100 of the illustrated example is capable of guiding an electromagnetic wave having a frequency of 30 GHz or more and 20 THz or less, in other words, electromagnetic waves ranging from a millimeter wave to a terahertz wave. The term “millimeter wave” typically refers to an electromagnetic wave having a frequency of from about 30 GHz to about 300 GHz, and the term “terahertz wave” typically refers to an electromagnetic wave having a frequency of from about 300 GHz to about 20 THz. In particular, the waveguide device 100 can guide an electromagnetic wave having a frequency of 30 GHz or more and 2 THz or less (in particular, an electromagnetic wave having a frequency of 30 GHz or more and 1 THz or less) while having excellent propagation loss performance.

The waveguide device 100 includes: an inorganic material substrate 1; a conductor layer 2 including a signal electrode 2a, and first earth electrodes 2b and 2c; a support substrate 7; a second earth electrode 3; a third earth electrode 4; and first vias 5.

The conductor layer 2 is arranged above (more specifically, on the upper surface of) the inorganic material substrate 1. The signal electrode 2a extends in a predetermined direction (waveguide direction). Each of the first earth electrodes 2b and 2c is arranged in a direction intersecting the predetermined direction in which the signal electrode 2a extends at a distance from the signal electrode 2a. The support substrate 7 is positioned on the opposite side to the conductor layer 2 with respect to the inorganic material substrate 1. The second earth electrode 3 is positioned between the inorganic material substrate 1 and the support substrate 7. The third earth electrode 4 is positioned on the opposite side to the second earth electrode 3 with respect to the support substrate 7. The first vias 5 electrically connect the first earth electrodes 2b and 2c, and the third earth electrode 4 to each other, and are electrically connected to the second earth electrode 3. Thus, the first earth electrodes 2b and 2c, the second earth electrode 3, and the third earth electrode 4 are electrically connected to each other. The thickness “t” of the inorganic material substrate 1 satisfies the following formula (1).

$$t < \frac{λ}{a \sqrt{ε}} \qquad ( 1 )$$

where “t” represents the thickness of the inorganic material substrate, λ represents the wavelength of an electromagnetic wave guided by the waveguide device, ε represents the relative dielectric constant of the inorganic material substrate at 300 GHz, and “a” represents a numerical value of 3 or more.

In the waveguide device including the conductor layer including the above-mentioned signal electrode, a high-frequency electromagnetic wave to be input to the waveguide device propagates in the inorganic material substrate.

With the above-mentioned configuration, the thickness of the inorganic material substrate satisfies the formula (1), and hence even when the waveguide device guides a high-frequency electromagnetic wave, the inducement of a slab mode and/or the occurrence of substrate resonance can be suppressed. However, when the thickness of the inorganic material substrate satisfies the formula (1), there may arise a new problem in that the electromagnetic wave to be propagated leaks from the inorganic material substrate to the support substrate, and hence a propagation loss due to the dielectric loss of the support substrate increases.

In contrast, in the above-mentioned configuration, the second earth electrode is arranged between the inorganic material substrate and the support substrate, and the third earth electrode is arranged on the opposite side to the second earth electrode with respect to the support substrate, and hence an electromagnetic wave can be suppressed from leaking to the support substrate. Accordingly, the leakage of the electromagnetic wave to the support substrate can be suppressed while the inducement of a slab mode and/or the occurrence of substrate resonance can be suppressed.

In addition, the first vias electrically connect the first earth electrodes, the second earth electrode, and the third earth electrode to each other. Accordingly, grounding can be strengthened, and hence stray capacitance due to a surrounding line or device can be suppressed. In addition, a heat-dissipating function can be imparted to the support substrate. Further, transmission in a high-order mode can be suppressed.

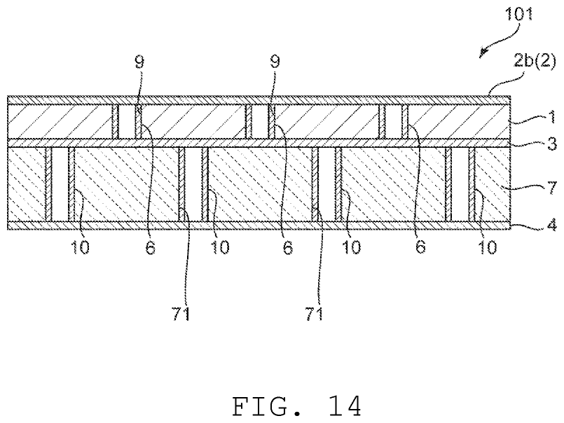

Further, in the above-mentioned configuration, the first vias electrically connect the first earth electrodes, the second earth electrode, and the third earth electrode to each other. Accordingly, relative positional accuracy between a portion in each of the first vias, which is s positioned between the corresponding first earth electrode and the second earth electrode, and a portion therein, which is positioned between the second earth electrode and the third earth electrode, can be simply secured. Accordingly, the occurrence of a ripple can be suppressed as compared to the case where vias, which connect the first earth electrodes and the second earth electrode to each other, and vias, which connect the second earth electrode and the third earth electrode to each other, are separately arranged (see FIG. 14).

As a result, even when a high-frequency electromagnetic wave having a frequency of 30 GHz or more is guided in the waveguide device, the propagation loss can be sufficiently reduced.

The waveguide device is being developed to be downsized, and is expected to integrate circuits in the future. In the above-mentioned waveguide device, thinning of the inorganic material substrate is achieved, and hence the demand for downsizing can be met while excellent propagation loss performance is secured.

In one embodiment, in the formula (1), “a” represents a numerical value of 6 or more.

When the thickness of the inorganic material substrate satisfies the formula (1) where “a” represents a numerical value of 6 or more, a reduction in propagation loss in the case of guiding the above-mentioned high-frequency electromagnetic wave can be stably achieved.

The dielectric constant of the inorganic material substrate 1 at from 100 GHz to 10 THz is, for example, 10.0 or less, preferably 3.7 or more and 10.0 or less, more preferably 3.8 or more and 9.0 or less. When a frequency to be used is 300 GHz, the relative dielectric constant ε of the inorganic material substrate 1 is typically 3.5 or more, and is typically 12.0 or less, preferably 10.0 or less, more preferably 5.0 or less. When the relative dielectric constant of the inorganic material substrate falls within such ranges, the delay of an electromagnetic wave to be propagated can be suppressed.

The dielectric loss tangent (tanδ) of the inorganic material substrate is preferably 0.01 or less, more preferably 0.008 or less, still more preferably 0.006 or less, particularly preferably 0.004 or less at the frequency to be used. When the frequency to be used is 300 GHz, the dielectric loss tangent tanδ in the inorganic material substrate 1 is preferably 0.0030 or less, more preferably 0.0020 or less, still more preferably 0.0015 or less.

When the dielectric loss tangent falls within such ranges, a propagation loss in a waveguide can be reduced. The dielectric loss tangent is preferably as small as possible. The dielectric loss tangent may be, for example, 0.001 or more.

When the relative dielectric constant ε and dielectric loss tangent (dielectric loss) tanδ of the inorganic material substrate fall within the above-mentioned ranges, a reduction in propagation loss in the case of guiding the above-mentioned high-frequency electromagnetic wave (in particular, an electromagnetic wave of 300 GHz or more) can be more stably achieved. The relative dielectric constant ε and the dielectric loss tangent (dielectric loss) tanδ may be measured by terahertz time-domain spectroscopy. In addition, herein, when there is no mention of a measurement frequency with regard to the relative dielectric constant and the dielectric loss tangent, the relative dielectric constant and the dielectric loss tangent at 300 GHz are meant.

The thickness of the inorganic material substrate 1 that satisfies the formula (1) is specifically 1 μm or more, preferably 2 μm or more, more preferably 10 μm or more, still more preferably 20 μm or more, and is, for example, 1,700 μm or less, preferably 500 μm or less, more preferably 200 μm or less, still more preferably 100 μm or less. In addition, when the frequency of the electromagnetic wave propagating in the waveguide device is 30 GHz or more and 5 THz or less, the thickness of the inorganic material substrate 1 is preferably 10 μm or more.

When the thickness of the inorganic material substrate 1 is smaller than the above-mentioned lower limits, the thickness and width of an electrode included in the waveguide device are reduced to about several micrometers, and hence the propagation loss is increased by the influence of a skin effect, and besides, a tolerance in line performance due to manufacturing variation is significantly reduced.

When the thickness of the inorganic material substrate 1 is equal to or smaller than the above-mentioned upper limits, the inducement of a slab mode and the occurrence of substrate resonance are suppressed, and hence a waveguide device having a small propagation loss over a wide frequency range (i.e., a broadband waveguide device) can be achieved.

In one embodiment, the waveguide device forms a coplanar line. That is, the conductor layer of the waveguide device is coplanar electrodes.

In one embodiment, the conductor layer 2 is coplanar electrodes. When the conductor layer 2 is the coplanar electrodes as illustrated in FIG. 2, the above-mentioned high-frequency electromagnetic wave is coupled to an electric field generated between the signal electrode 2a and each of the first earth electrodes 2b and 2c to be propagated in the inorganic material substrate 1.

When the conductor layer 2 is the coplanar electrodes, the signal electrode 2a has a line shape extending in the predetermined direction (waveguide direction). The first earth electrode 2b is arranged in a direction intersecting (preferably, perpendicular to) the longitudinal direction of the signal electrode 2a so as to form a predetermined clearance (gap) between itself and the signal electrode 2a. The first earth electrode 2c is positioned on the opposite side to the first earth electrode 2b with respect to the signal electrode 2a in a direction intersecting (preferably, perpendicular to) the longitudinal direction of the signal electrode 2a, and is arranged so as to form a predetermined clearance (gap) between itself and the signal electrode 2a. The clearances (gaps) each extend in the longitudinal direction of the signal electrode 2a.

The width (dimension in the direction perpendicular to the longitudinal direction) “w” of the signal electrode 2a of the coplanar electrodes is, for example, 2 μm or more, preferably 20 μm or more, and is, for example, 200 μm or less, preferably 150 μm or less.

The width (dimension in a direction intersecting the longitudinal direction) “g” of the above-mentioned clearance (gap) is, for example, 2 μm or more, preferably 5 μm or more, and is, for example, 100 μm or less, preferably 80 μm or less.

In one embodiment, the waveguide device forms a microstrip line. That is, the conductor layer and second earth electrode of the waveguide device are microstrip electrodes.

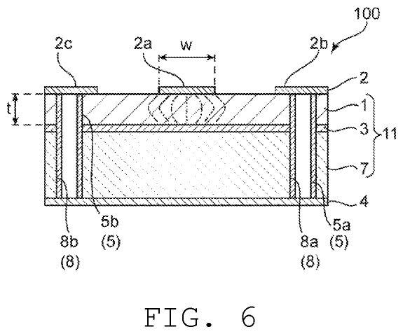

In one embodiment, the conductor layer 2 and the second earth electrode 3 are microstrip electrodes. When the conductor layer 2 and the second earth electrode 3 are the microstrip electrodes as illustrated in FIG. 6, the above-mentioned high-frequency electromagnetic wave is coupled to an electric field generated between the signal electrode 2a and the second earth electrode 3 to be propagated in the inorganic material substrate 1.

When the conductor layer 2 is the microstrip electrodes, the signal electrode 2a has a flat band shape extending in the predetermined direction (waveguide direction). The second earth electrode 3 is arranged in a direction intersecting (preferably, perpendicular to) the longitudinal direction of the signal electrode 2a so as to form a predetermined gap (thickness of the inorganic material substrate) between itself and the signal electrode 2a. The gap extends in the longitudinal direction of the signal electrode 2a. Meanwhile, the first earth electrodes 2b and 2c may be arranged as in the coplanar electrodes, and the first earth electrodes 2b and 2c are each positioned away from the signal electrode 2a by a distance longer than the width “g” of each of the clearances (gaps) of the coplanar electrodes described above in a direction intersecting (preferably, perpendicular to) the longitudinal direction of the signal electrode 2a.

The width (dimension in the direction perpendicular to the longitudinal direction) “w” of the signal electrode 2a of the microstrip electrodes is, for example, 2 μm or more, preferably 100 μm or more, more preferably 300 μm or more, and is, for example, 800 μm or less, preferably 500 μm or less.

In each of the illustrated examples, the signal electrode 2a extends over the entirety of the waveguide device 100 no matter which one of the coplanar electrodes or the microstrip electrodes the conductor layer 2 is. However, the dimension of the signal electrode 2a in its longitudinal direction may be set to any appropriate dimension as long as the dimension is equal to or less than the dimension of the waveguide device in its waveguide direction. In addition, the plurality of signal electrodes may be arranged in the waveguide device so as to be arranged in the waveguide direction.

### A-2. Overall Configuration of Waveguide Device 101

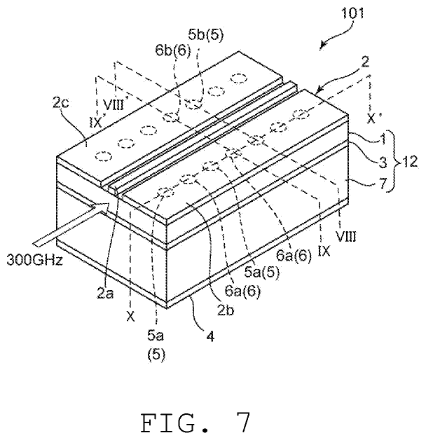

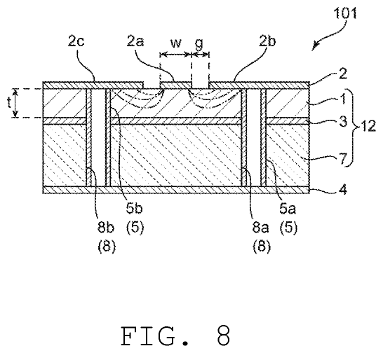

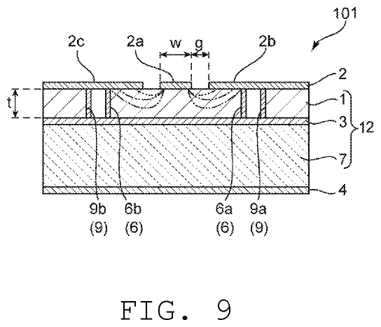

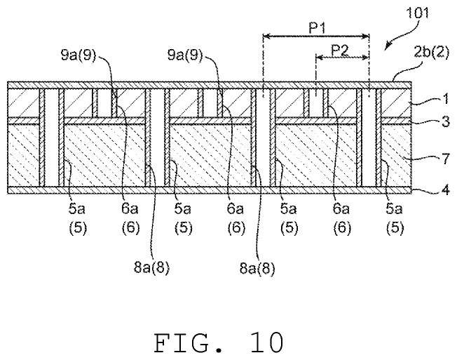

FIG. 7 is a schematic perspective view of a waveguide device according to one embodiment of the present invention, FIG. 8 is a cross-sectional view of the waveguide device taken along the line VIII-VIII′ of FIG. 7, FIG. 9 is a cross-sectional view of the waveguide device taken along the line IX-IX′ of FIG. 7, and FIG. 10 is a cross-sectional view of the waveguide device taken along the line X-X′ of FIG. 7.

A waveguide device 101 of the illustrated example is capable of guiding an electromagnetic wave having a frequency of 30 GHz or more and 20 THz or less, in other words, the above-mentioned electromagnetic waves ranging from a millimeter wave to a terahertz wave. In particular, the waveguide device 101 can guide an electromagnetic wave having a frequency of 30 GHz or more and 2 THz or less (in particular, an electromagnetic wave having a frequency of 30 GHz or more and 1 THz or less) while having excellent propagation loss performance.

The waveguide device 101 includes: the inorganic material substrate 1; the conductor layer 2 including the signal electrode 2a, and the first earth electrodes 2b and 2c; the support substrate 7; the second earth electrode 3; the third earth electrode 4; the first vias 5; and second vias 6. In other words, the waveguide device 101 has the same configuration as that of the waveguide device 100 except that the device further includes the second vias 6.

The conductor layer 2 is arranged above (more specifically, on the upper surface of) the inorganic material substrate 1. The signal electrode 2a extends in a predetermined direction (waveguide direction). Each of the first earth electrodes 2b and 2c is arranged in a direction intersecting the predetermined direction in which the signal electrode 2a extends at a distance from the signal electrode 2a. The support substrate 7 is positioned on the opposite side to the conductor layer 2 with respect to the inorganic material substrate 1. The second earth electrode 3 is positioned between the inorganic material substrate 1 and the support substrate 7. The third earth electrode 4 is positioned on the opposite side to the second earth electrode 3 with respect to the support substrate 7. The first vias 5 electrically connect the first earth electrodes 2b and 2c, and the third earth electrode 4 to each other, and are electrically connected to the second earth electrode 3. The waveguide device 101 includes the plurality of first vias 5 described above. The second vias 6 electrically connect the first earth electrodes 2b and 2c, and the second earth electrode 3 to each other. Thus, the first earth electrodes 2b and 2c, the second earth electrode 3, and the third earth electrode 4 are electrically connected to each other. The second vias 6 are each arranged between the first vias 5 adjacent to each other out of the plurality of first vias 5. The thickness “t” of the inorganic material substrate 1 satisfies the formula (1).

With the above-mentioned configuration, the second vias are each arranged between the first vias adjacent to each other, and hence a pitch between the first via and the second via in the inorganic material substrate can be made smaller than a pitch between the first vias in the support substrate. Accordingly, even when the inorganic material substrate is thinned as described above, the strength of the inorganic material substrate can be sufficiently secured.

In addition, as illustrated in FIG. 14, the waveguide device 101 may include third vias 10 instead of the first vias 5. In other words, the waveguide device 101 includes: the inorganic material substrate 1; the conductor layer 2 including the signal electrode 2a, and the first earth electrodes 2b and 2c; the support substrate 7; the second earth electrode 3; the third earth electrode 4; the second vias 6; and the third vias 10. The third vias 10 electrically connect the second earth electrode 3 and the third earth electrode 4 to each other.

With such configuration, the second vias connect the first earth electrodes and the second earth electrode to each other, and the third vias connect the second earth electrode and the third earth electrode to each other. Accordingly, the first earth electrodes, the second earth electrode, and the third earth electrode can be electrically connected to each other. In this case as well, grounding can be strengthened, and hence stray capacitance due to a surrounding line or device can be suppressed.

As used herein, the term “waveguide device” encompasses both of a wafer having formed thereon at least one waveguide device (waveguide device wafer) and a chip obtained by cutting the waveguide device wafer.

Specific configurations of the components of the waveguide device are described in the section B to the section I below. In addition, a method of producing a waveguide device is described in the section J.

### B. Inorganic Material Substrate

The inorganic material substrate 1 has an upper surface on which the conductor layer 2 is arranged, and a lower surface positioned inside a composite substrate.

The inorganic material substrate 1 includes an inorganic material. Any appropriate material may be used as the inorganic material as long as the effects according to the embodiments of the present invention are obtained. Typical examples of such material include monocrystalline quartz (relative dielectric constant: 4.5, dielectric loss tangent: 0.0013), amorphous quartz (quartz glass, relative dielectric constant: 3.8, dielectric loss tangent: 0.0010), spinel (relative dielectric constant: 8.3, dielectric loss tangent: 0.0020), AlN (relative dielectric constant: 8.5, dielectric loss tangent: 0.0015), sapphire (relative dielectric constant: 9.4, dielectric loss tangent: 0.0030), SiC (relative dielectric constant: 9.8, dielectric loss tangent: 0.0022), magnesium oxide (relative dielectric constant: 10.0, dielectric loss tangent: 0.0012), and silicon (relative dielectric constant: 11.7, dielectric loss tangent: 0.0016) (The relative dielectric constants and the dielectric loss tangents in parentheses each represent a numerical value at a frequency of 300 GHz). The inorganic material substrate 1 is preferably a quartz glass substrate including amorphous quartz.

When the inorganic material substrate is a quartz glass substrate, even in the case of guiding the above-mentioned high-frequency electromagnetic wave, an increase in propagation loss can be still more stably suppressed. Further, the quartz glass substrate has a large dielectric constant as compared to a resin-based substrate, and hence can be reduced in substrate size, and besides, has a relatively small dielectric constant among inorganic materials, and hence is advantageous in achieving a low delay.

The resistivity of the inorganic material substrate 1 is, for example, 100 kΩ·cm or more, preferably 300 kΩ·cm or more, more preferably 500 kΩ·cm or more, still more preferably 700 kΩ·cm or more. When the resistivity falls within such ranges, an electromagnetic wave can propagate in the material with a low loss without influencing electronic conduction. This phenomenon is not clear in detail, but it may be presumed that, when the resistivity is small, the electromagnetic wave couples with an electron, and hence the energy of the electromagnetic wave is consumed by electronic conduction, resulting in a loss. From this viewpoint, the resistivity is preferably as large as The possible. resistivity may be, for example, 3,000 kΩ (3 MΩ)·cm or less.

The bending strength of the inorganic material substrate 1 is, for example, 50 MPa or more, preferably 60 MPa or more. When the bending strength falls within such ranges, the substrate is hardly deformed so as to make a hole diameter and a hole period stable, and hence a waveguide device with little changes in characteristics can be achieved. The bending strength is preferably as large as possible. The bending strength may be, for example, 700 MPa or less. The bending strength may be measured in conformity with the JIS standard R1601.

The thermal expansion coefficient (linear expansion coefficient) of the inorganic material substrate 1 is, for example, 10×10⁻⁶/K or less, preferably 8×10⁻⁶/K or less. When the thermal expansion coefficient falls within such ranges, thermal deformation (typically, warpage) of the substrate can be satisfactorily suppressed. The thermal expansion coefficient may be measured in conformity with the JIS standard R1618.

In addition, as described above, the dielectric loss tangent tanδ in the inorganic material substrate 1 is preferably as small as possible. A method of reducing the dielectric loss tangent (tanδ) of the inorganic material substrate 1 in the 300 GHz band involves, for example, reducing the OH group concentration in the inorganic material substrate. When the waveguide device guides an electromagnetic wave having a frequency of from 250 GHz to 350 GHz, the OH group concentration in the inorganic material substrate is, for example, 100 wtppm or less, preferably 15 wtppm or less, more preferably 10 wtppm or less. The OH group concentration in the inorganic material substrate may be typically 0 wtppm or more. The OH group concentration may be measured by Fourier transform infrared spectroscopy (FTIR), Raman scattering spectroscopy, or the Karl Fischer method.

In addition, the dielectric loss of the inorganic material substrate 1 may be evaluated in terms of FQ value. The FQ value is calculated as the product of the reciprocal of the dielectric loss tangent (tanδ) and the frequency of the electromagnetic wave guided by the waveguide device.

In the case where the OH group concentration of the inorganic material substrate 1 is 100 wtppm or less, when the frequency of the electromagnetic wave is 150 GHz or more and less than 250 GHz, the FQ value is preferably 45,000 GHz or more, and when the frequency of the electromagnetic wave is a frequency of 250 GHz or more and less than 350 GHz, the FQ value is preferably 75,000 GHz or more.

In addition, in the case where the OH group concentration of the inorganic material substrate 1 is 15 wtppm or less, when the frequency of the electromagnetic wave is 150 GHz or more and less than 250 GHz, the FQ value is preferably 75,000 GHz or more, and when the frequency of the electromagnetic wave is 250 GHz or more and less than 350 GHz, the FQ value is preferably 105,000 GHz or more.

Further, in the case where the OH group concentration of the inorganic material substrate 1 is 10 wtppm or less, when the frequency of the electromagnetic wave is 150 GHz or more and less than 250 GHz, the FQ value is preferably 150,000 GHz or more, and is typically 270,000 GHz or less, and when the frequency of the electromagnetic wave is a frequency of 250 GHz or more and less than 350 GHz, the FQ value is preferably 250,000 GHz or more, and is typically 390,000 GHz or less.

The porosity of the inorganic material substrate 1 is as follows: pores each having a pore size of 1 μm or more account for, for example, 0.5 ppm or more and 3,000 ppm or less, preferably 0.5 ppm or more and 1,000 ppm or less, more preferably 0.5 ppm or more and 100 ppm or less of the substrate. When the porosity falls within such ranges, the substrate can be densified. Further, a waveguide device that is stable from both the viewpoints of mechanical strength and long-term reliability can be achieved by a synergistic effect with an effect exhibited by the setting of the above-mentioned hole size within a predetermined range. Further, the diameters of particles in the substrate can be reduced, and hence there is an advantage in that the shapes of via holes to be described later can be uniformized without variation. When the porosity is more than 3,000 ppm, the propagation loss in the waveguide is increased in some cases. It is difficult to set the porosity to less than 0.5 ppm in a technology including using an inorganic material substrate.

The size of a pore refers to the following: its diameter when the pore has an approximately spherical shape; its diameter as viewed in plan view when the pore has an approximately columnar shape; and the diameter of a circle inscribed in the pore when the pore has any other shape. The presence or absence of pores may be recognized, for example, by optical computed tomography (CT) or with a transmittance-measuring instrument. The sizes of the pores may be measured with, for example, a scanning electron microscope (SEM).

### C. Conductor Layer

The conductor layer 2 is positioned on the opposite side to the second earth electrode 3 with respect to the inorganic material substrate 1, and is arranged on the front surface of the inorganic material substrate 1. The conductor layer 2 is typically brought into direct contact with the inorganic material substrate 1.

The conductor layer 2 typically includes a metal. Examples of the metal include chromium (Cr), nickel (Ni), copper (Cu), gold (Au), silver (Ag), palladium (Pd), and titanium (Ti). The metals may be used alone or in combination thereof. The conductor layer 2 may be a single layer, or may be formed as a laminate of two or more layers. The conductor layer 2 is formed on the inorganic material substrate 1 by, for example, plating, sputtering, vapor deposition, or printing.

The thickness of the conductor layer 2 is, for example, 1 μm or more, preferably 4 μm or more, and is, for example, 20 μm or less, preferably 10 μm or less.

### D. Second Earth Electrode

In one embodiment, the second earth electrode 3 is arranged on the surface of the inorganic material substrate 1 on the opposite side to the conductor layer 2. The second earth electrode 3 is arranged at a distance from the signal electrode 2a in the thickness direction of the inorganic material substrate 1. The second earth electrode 3 is typically brought into direct contact with the inorganic material substrate 1. The second earth electrode 3 may include the same metal as that of the conductor layer 2. From the viewpoint of joining the inorganic material substrate 1 and the support substrate 7 to each other, the second earth electrode 3 needs to secure adhesive strength with which joining surfaces can be easily planarized, and the metal of the second earth electrode 3 may be different from the metal of the conductor layer 2. The range of the thickness of the second earth electrode 3 is the same as the range of the thickness of the conductor layer 2.

The second earth electrode 3 is typically formed on the inorganic material substrate 1 by sputtering or plating.

### E. Support Substrate

The support substrate 7 can impart excellent mechanical strength to the waveguide device. Thus, the thickness “t” of the inorganic material substrate can be reduced so as to satisfy the formula (1). Any appropriate configuration may be adopted as the support substrate 7. Specific examples of a material for forming the support substrate 7 include indium phosphide (InP), silicon (Si), glass, SiAlON (Si₃N₄—Al₂O₃), mullite (3Al₂O₃·2SiO₂, 2Al₂O₃·3SiO₂), aluminum nitride (AlN), magnesium oxide (MgO), aluminum oxide (Al₂O₃), spinel (MgAl₂O₄), sapphire, quartz, crystal, gallium nitride (GaN), silicon carbide (SiC), silicon nitride (Si₃N₄), and gallium oxide (Ga₂O₃).

The support substrate 7 preferably includes at least one kind selected from indium phosphide, silicon, aluminum nitride, silicon carbide, and silicon nitride, and more preferably includes silicon.

When an active device, such as an oscillator or a receiver, is mounted on the waveguide device, the inorganic material substrate may be heated to degrade the characteristics of the other active device or mounted part. In order to prevent this situation, a material having a high thermal conductivity may be used for the support substrate. In this case, the thermal conductivity is preferably 150 W/Km or more, and examples of the material for forming the support substrate 7 in this viewpoint include silicon (Si), aluminum nitride (AlN), gallium nitride (GaN), silicon carbide (SiC), and silicon nitride (Si₃N₄).

The linear expansion coefficient of the material for forming the support substrate 7 is preferably as close to the linear expansion coefficient of the material for forming the inorganic material substrate 1 as possible. With such configuration, thermal deformation (typically, warpage) of the composite substrate can be suppressed. The linear expansion coefficient of the material for forming the support substrate 7 preferably falls within the range of from 50% to 150% with respect to the linear expansion coefficient of the material for forming the inorganic material substrate 1.

In addition, the dielectric loss tangent of the material for forming the support substrate 7 is preferably smaller. In the case of a coplanar line, when the thickness of the waveguide device is small, the propagating electromagnetic wave may leak to the support substrate, and the propagation loss can be suppressed by reducing the dielectric loss tangent. From this viewpoint, the dielectric loss tangent of the support substrate 7 is preferably 0.07 or less.

The thickness of the support substrate 7 is, for example, 50 μm or more, preferably 100 μm or more, more preferably 150 μm or more, and is, for example, 3,000 μm or less, preferably 2,000 μm or less, more preferably 300 μm or less. In addition, in one embodiment, the thickness of the support substrate 7 is larger than the thickness of the inorganic material substrate. More specifically, the thickness of the support substrate 7 is, for example, 1.1 or more times, preferably 1.5 or more times as large as the thickness of the inorganic material substrate, and is, for example, 30 or less times, preferably 10 or less times, more preferably 5 or less times as large as the thickness. When the thickness of the support substrate is equal to or larger than the above-mentioned lower limits, an improvement in mechanical strength of the waveguide device can be stably achieved. When the thickness of the support substrate is equal to or smaller than the above-mentioned upper limits, the suppression of slab-mode propagation, the thinning of the waveguide device (retention of the mechanical strength of the waveguide device), and the suppression of substrate resonance can be achieved.

The support substrate 7 supports the conductor layer 2, the inorganic material substrate 1, and the second earth electrode 3. More specifically, the support substrate 7 may be directly joined to the inorganic material substrate 1 only via the second earth electrode 3, or may be directly joined to the inorganic material substrate 1 via the second earth electrode 3 and a joining portion (not shown).

As used herein, the term “direct joining” means that two layers or substrates are joined to each other without an adhesive (typically an organic adhesive) being interposed therebetween. The form of the direct joining may be appropriately set in accordance with the configurations of the layers or substrates to be joined to each other.

When those components are integrated by the direct joining, peeling in the waveguide device can be satisfactorily suppressed, and as a result, damage (e.g., a crack) to the inorganic material substrate resulting from such peeling can be satisfactorily suppressed. Details about the direct joining are described in the section J to be described later.

When the support substrate 7 is joined to the inorganic material substrate 1 only via the second earth electrode 3, the second earth electrode 3 functions as a joining portion that joins the inorganic material substrate 1 and the support substrate 7 to each other, and the support substrate 7 is brought into direct contact with the second earth electrode 3.

When the support substrate 7 is joined to the inorganic material substrate 1 via the second earth electrode 3 and the joining portion, the joining portion is arranged between the second earth electrode 3 and the support substrate 7. The joining portion may be one layer, or may be a laminate of two or more layers. Examples of the joining portion include a SiO₂ layer, an amorphous silicon layer, and a tantalum oxide layer. In addition, from the viewpoints of securing adhesive strength and preventing migration, a metal film of Ti, Cr, Ni, Pt, or Pd may be formed as an intermediate layer between the inorganic material substrate and the second earth electrode or between the support substrate and the second earth electrode. The thickness of the joining portion is, for example, 0.01 μm or more and 3 μm or less.

### F. Third Earth Electrode

In one embodiment, the third earth electrode 4 is arranged on the surface of the support substrate 7 on the opposite side to the second earth electrode 3. The third earth electrode 4 is arranged at a distance from the second earth electrode 3 in the thickness direction of the inorganic material substrate 1. The third earth electrode 4 is typically brought into direct contact with the support substrate 7. The third earth electrode 4 includes the same metal as that of the conductor layer 2, and the range of the thickness of the third earth electrode 4 is the same as the range of the thickness of the conductor layer 2. The third earth electrode 4 is formed on the support substrate 7 by, for example, sputtering or plating. The third earth electrode 4 is not necessarily required to be formed over the entire surface of the support substrate 7 on the opposite side to the second earth electrode.

### G. First Vias

As illustrated in FIG. 1, in the waveguide device 100, the first vias 5 are arranged on both the sides of the signal electrode 2a in a direction intersecting (preferably, perpendicular to) the longitudinal direction of the signal electrode 2a. In the following description, the first via, which electrically connects the first earth electrode 2b and the third earth electrode 4 to each other, and the first via, which electrically connects the first earth electrode 2c and the third earth electrode 4 to each other, may be distinguished from each other by being referred to as “first via 5a” and “first via 5b, ” respectively.

As illustrated in FIG. 2, the first via 5a is brought into contact with the first earth electrode 2b and the third earth electrode 4, and continuously extends between the first earth electrode 2b and the third earth electrode 4. The first via 5b is brought into contact with the first earth electrode 2c and the third earth electrode 4, and continuously extends between the first earth electrode 2c and the third earth electrode 4. Each of the first vias 5a and 5b penetrates through the second earth electrode 3, and is brought into contact with the second earth electrode 3. The waveguide device may include only one of the first via 5a or 5b.

The first vias 5 are each typically a conductive film. Each of the first vias 5 includes a conductor material, and typically includes the same metal as that of the conductor layer 2. The shape of each of the first vias 5 corresponds to the shape of a first via hole 8 in which the via is arranged. In other words, the waveguide device 100 includes the plurality of first via holes 8 in correspondence with the plurality of first vias 5. In the illustrated example, the first via hole in which the first via 5a is arranged and the first via hole in which the first via 5b is arranged may be distinguished from each other by being referred to as “first via hole 8a” and “first via hole 8b,” respectively. The first via holes 8 each penetrate through the inorganic material substrate 1, the second earth electrode 3, and the support substrate 7. The first via holes 8 each typically have a circular shape when viewed from the front surface (upper surface) direction of (above) the inorganic material substrate 1. When the first via holes each have a circular shape, the inner diameter of each of the first via holes is, for example, 10 μm or more, preferably 20 μm or more, and is, for example, 200 μm or less, preferably 100 μm or less, more preferably 80 μm or less.

In FIG. 2, each of the first via holes 8 has a circular shape when viewed from the front surface (upper surface) direction of (above) the inorganic material substrate 1, and linearly penetrates through the inorganic material substrate 1, the second earth electrode 3, and the support substrate 7 along the front surface (upper surface) direction (thickness direction) of the inorganic material substrate 1. In the case where the first via holes are circular and linear, the first vias 5 each have a columnar shape or a cylindrical shape extending along the front surface (upper surface) direction (thickness direction) of the inorganic material substrate 1. In this case, the ranges of the outer diameter of each of the first vias 5 are the same as the ranges of the inner diameter of each of the first via holes described above.

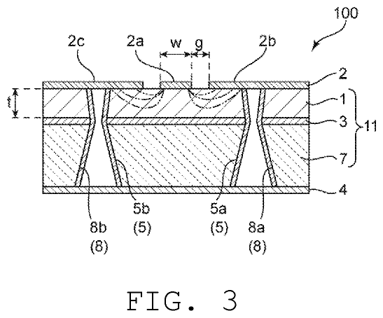

As illustrated in FIG. 3, each of the first via holes 8 may have a circular shape when viewed from the front surface (upper surface) direction of (above) the inorganic material substrate 1, and have such a tapered shape that its diameter becomes smaller as its distance from the second earth electrode 3 becomes shorter. In addition, each of the first via holes 8 may have a circular shape when viewed from the front surface (upper surface) direction of (above) the inorganic material substrate 1, and have such a tapered shape that its diameter becomes larger as its distance from the second earth electrode 3 becomes shorter, though the tapered shape is not shown.

When the first via holes each have a tapered shape, the following features can be imparted to each of the via holes: it becomes easier to form the conductor layer in the first via; and it becomes easier to secure the strength of the substrate. In addition, the first vias may be formed so that the conductor material may be embedded in each of the first via holes.

When the first via holes each have a circular shape and a tapered shape, the structure of each of the first vias 5 is not particularly limited, but the first vias 5 each preferably have such an hourglass shape that its portion in contact with the second earth electrode 3 has a small diameter, and its diameter becomes larger as its distance from the second earth electrode 3 becomes longer. In other words, the first vias 5 each preferably have a shape obtained by linking the apices of two cones to each other. In this case, the maximum outer diameter of each of the first vias 5 falls within the above-mentioned ranges. In one embodiment, the outer diameter of one end portion of each of the first vias 5 in contact with the corresponding first earth electrodes 2b and 2c is smaller than the outer diameter of the other end portion of the first via 5 in contact with the third earth electrode 4. In each of the first vias 5, a taper angle on the conductor layer 2 side with respect to the second earth electrode is smaller than a taper angle on the third earth electrode side with respect to the second earth electrode.

In the illustrated example, the first earth electrodes and the third earth electrode are each formed so as to close the first via holes. However, the configurations of the first earth electrodes and the third earth electrode are not limited thereto. Each of the first earth electrodes and the third earth electrode only needs to be conducted to the first vias, and may be opened without closing the first via holes.

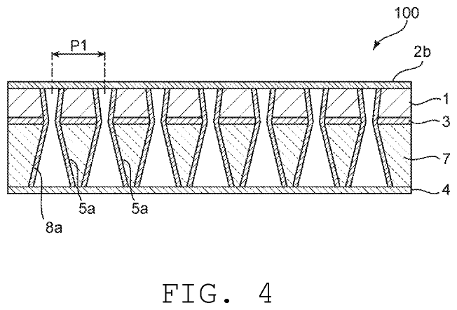

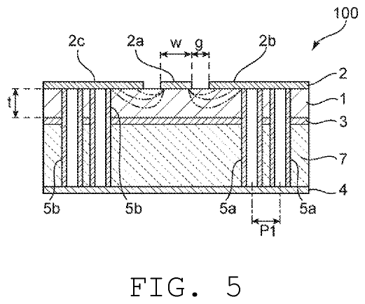

In addition, as illustrated in FIG. 4, in the waveguide device 100, the plurality of first vias 5a are arranged at a distance from each other in the longitudinal direction of the signal electrode 2a. The direction in which the plurality of first vias 5a are arranged is not limited to the longitudinal direction of the signal electrode 2a. As illustrated in FIG. 5, the plurality of first vias 5a may be arranged at a distance from each other in a direction intersecting (preferably, perpendicular to) the longitudinal direction of the signal electrode 2a. In other words, the waveguide device may include, in the direction intersecting (perpendicular to) the longitudinal direction of the signal electrode 2a, a plurality of rows of the first vias 5a arranged in the longitudinal direction of the signal electrode 2a.

A pitch P1 between the plurality of first vias 5a (distance between the centers of the first vias 5a adjacent to each other) is, for example, 40 μm or more, preferably 60 μm or more, and is, for example, 600 μm or less, preferably 400 μm or less, more preferably 200 μm or less.

In addition, the waveguide device 100 may include the plurality of first vias 5b as in the first vias 5a.

### H. Second Vias

As illustrated in each of FIG. 7 to FIG. 9, in the waveguide device 101, the second vias 6 are arranged on both the sides of the signal electrode 2a in a direction intersecting (preferably, perpendicular to) the longitudinal direction of the signal electrode 2a. In the following description, the second via, which electrically connects the first earth electrode 2b and the second earth electrode 3 to each other, and the second via, which electrically connects the first earth electrode 2c and the second earth electrode 3 to each other, may be distinguished from each other by being referred to as “second via 6a” and “second via 6b,” respectively. The second via 6a is brought into contact with the first earth electrode 2b and the second earth electrode 3, and is out of contact with the third earth electrode 4. The second via 6b is brought into contact with the first earth electrode 2c and the second earth electrode 3, and is out of contact with the third earth electrode 4. The waveguide device may include only one of the second via 6a or 6b.

The second vias 6 are each typically a conductive film. Each of the second vias 6 includes a conductor material, and typically includes the same metal as that of each of the first vias 5. The shape of each of the second vias 6 corresponds to the shape of a second via hole 9 in which the via is arranged. In other words, the waveguide device 101 includes the second via holes 9 corresponding to the second vias 6. In the illustrated example, the second via hole in which the second via 6a is arranged and the second via hole in which the second via 6b is arranged may be distinguished from each other by being referred to as “second via hole 9a” and “second via hole 9b,” respectively.

Each of the second via holes 9 penetrates through at least the inorganic material substrate 1, and does not penetrate through the support substrate 7. The second via holes 9 each typically have a circular shape when viewed from the front surface (upper surface) direction of (above) the inorganic material substrate 1. When the second via holes each have a circular shape, the ranges of the inner diameter of each of the second via holes are the same as, for example, the ranges of the inner diameter of each of the first via holes described above.

In FIG. 9, each of the second via holes 9 has a circular shape when viewed from the front surface (upper surface) direction of (above) the inorganic material substrate 1, and linearly penetrates through the inorganic material substrate 1 along the front surface (upper surface) direction (thickness direction) of the inorganic material substrate 1. The second via holes 9 illustrated in each of FIG. 9 and FIG. 10 do not penetrate through the second earth electrode 3. In the case where the second via holes 9 are circular and linear, the second vias 6 each have a columnar shape or a cylindrical shape extending along the thickness direction of the inorganic material substrate 1. In this case, the ranges of the outer diameter of each of the second vias 6 are the same as the ranges of the inner diameter of each of the second via holes described above.

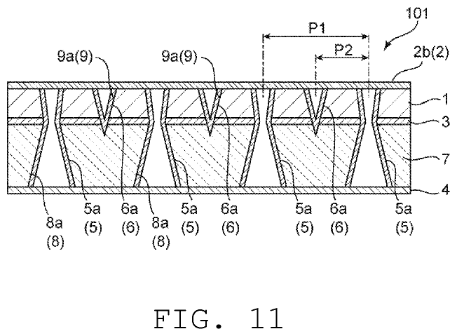

As illustrated in FIG. 11, the second via holes 9 may each have a conical shape that tapers as its distance from the conductor layer 2 becomes longer. Each of the second via holes 9 illustrated in FIG. 11 penetrates through the inorganic material substrate 1 and the second earth electrode 3, and its tip reaches the support substrate 7. In the case where the second via holes 9 have conical shapes, the structures of the second vias 6 are not particularly limited, but the second vias 6 preferably have the same conical shapes as those of the second via holes 9. In this case, the maximum outer diameter of each of the second vias 6 falls within the ranges of the inner diameter of each of the second via holes described above. In addition, the apex portions of the second vias 6 (end portions of the second vias 6 on the opposite side to the conductor layer 2) may reach the support substrate 7.

In the illustrated example, the first earth electrodes are formed so as to close the second via holes. However, the configurations of the first earth electrodes are not limited thereto. Each of the first earth electrodes only needs to be conducted to the second vias, and may be opened without closing the second via holes.

As illustrated in each of FIG. 10 to FIG. 13, the second vias 6 are each arranged between the first vias 5 adjacent to each other out of the plurality of first vias 5 arranged in a predetermined direction. The second vias 6 are each typically positioned at the center of an interval between the first vias 5 adjacent to each other.

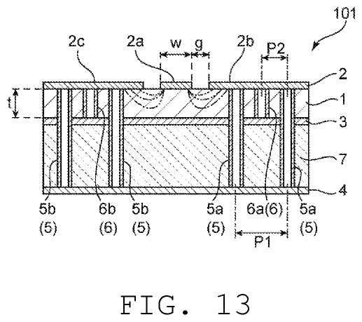

The waveguide device 101 of the illustrated example includes the plurality of second vias 6 (the plurality of second vias 6a and the plurality of second vias 6b). In the waveguide device 101 illustrated in each of FIG. 10 to FIG. 12, the second vias 6 are each arranged between the first vias 5 adjacent to each other out of the plurality of first vias 5 (the first vias 5a or the first vias 5b) arranged in the longitudinal direction of the signal electrode 2a. In the waveguide device 101 illustrated in FIG. 13, the second vias 6 are each arranged between the first vias 5 adjacent to each other out of the plurality of first vias 5 (the first vias 5a or the first vias 5b) arranged in a direction intersecting (preferably, perpendicular to) the longitudinal direction of the signal electrode 2a.

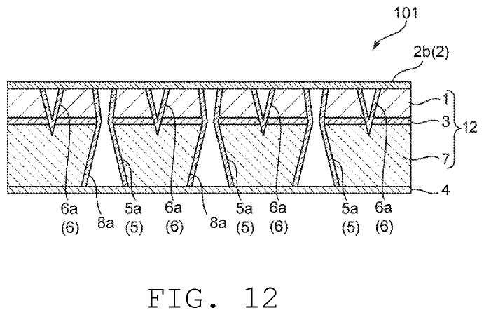

In addition, each of the second vias 6 may be arranged at any appropriate position as long as the via is present between the first vias 5 adjacent to each other. The second vias 6 may each be arranged every “n” first vias 5 in the direction in which the plurality of first vias are arranged. “n” represents, for example, 1 or more and 5 or less, preferably 1 or 2. It is more preferred that the first vias 5 and the second vias 6 be alternately arranged. In addition, all of the plurality of second vias 6 may each be arranged between the first vias 5 adjacent to each other as illustrated in each of FIG. 10 and FIG. 11, or the second via 6 that is not arranged between the first vias 5 may be present as illustrated in FIG. 12 as long as at least one of the vias is arranged between the first vias 5 adjacent to each other.

A pitch P2 between the first via 5 and the second via 6 adjacent to each other (distance between the centers of the first via 5a and the second via 6a adjacent to each other) is substantially ½ of the pitch P1 (distance between the centers of the first vias 5a adjacent to each other), and the pitch is, for example, 25 μm or more, preferably 60 μm or more, and is, for example, 600 μm or less, preferably 400 μm or less, more preferably 200 μm or less.

When the second vias 6 are each arranged between the first vias 5 adjacent to each other as described above, the pitch P2 between the first via 5 and the second via 6 in the inorganic material substrate 1 can be made smaller than the pitch P1 between the first vias 5 in the support substrate 7. Accordingly, even when the inorganic material substrate is thinned as described above, the strength of the inorganic material substrate can be sufficiently secured.

In addition, when the first via holes 8 each have such a tapered shape that its diameter becomes larger as its distance from the second earth electrode 3 becomes longer, and the thickness of the support substrate 7 is larger than that of the inorganic material substrate 1 as illustrated in FIG. 11, the outer diameter of one end portion of each of the first vias 5 in contact with the corresponding first earth electrodes 2b and 2c becomes smaller than the outer diameter of the other end portion of the first via 5 in contact with the third earth electrode 4 in some cases. In such cases, when a pitch between the plurality of first vias 5 is narrowed like the above-mentioned pitch P2 without the arrangement of the second via 6, the other end portions of the first vias 5 may interfere with each other. In contrast, in the waveguide device 101, the second vias 6 are each arranged between the first vias 5 adjacent to each other, and hence the interference between the first vias 5 can be suppressed.

### I. Third Vias

As illustrated in FIG. 14, the waveguide device 101 may include the plurality of third vias 10 instead of the plurality of first vias 5. The third vias 10 are brought into contact with the second earth electrode 3 and the third earth electrode 4, and are out of contact with the first earth electrodes 2b and 2c. The third vias 10 are each typically a conductive film. The third vias 10 each include a conductor material, and each typically include the same metal as that of each of the first vias 5. The shape of each of the third vias 10 corresponds to the shape of a substrate via hole 71 in which the via is arranged. In other words, the waveguide device 101 may have the substrate via holes 71 corresponding to the third vias 10. The substrate via holes 71 penetrate through at least the support substrate 7.

### J. Method of producing Waveguide Device

Next, a method of producing the waveguide device 100 is described with reference to FIG. 1 and FIG. 2. In one embodiment, the method of producing the waveguide device 100 includes the steps of: preparing a laminate 11, which includes the inorganic material substrate 1, the second earth electrode 3, and the support substrate 7 in the stated order, and has the first via holes 8 collectively penetrating through the inorganic material substrate 1, the second earth electrode 3, and the support substrate 7; and forming the conductor layer 2 above the inorganic material substrate 1, forming the first vias 5 in the first via holes 8, and forming the third earth electrode 4 below the support substrate 7.

To prepare the laminate 11, for example, the inorganic material substrate 1 and the support substrate 7 are directly joined to each other. When the inorganic material substrate 1 and the support substrate 7 are joined to each other via the second earth electrode 3, first, the metal for forming the second earth electrode 3 described above is sputtered on the surface of the inorganic material substrate 1 described above to form a first metal thin film serving as a first joining portion. Further, the metal for forming the second earth electrode 3 described above is sputtered on the surface of the support substrate 7 described above to form a second metal thin film serving as a second joining portion. With regard to the formation of the first metal thin film and the second metal thin film, a metal film of Ti, Cr, Ni, Pt, or Pd may be formed as an intermediate layer from the viewpoints of securing adhesive strength and preventing migration.

Next, in a high-vacuum chamber (e.g., about 1×10⁻⁶ Pa), the joining surface of each of components (layers or substrates) to be joined to each other is irradiated with a neutralized beam. Thus, each joining surface is activated. Next, in a vacuum atmosphere, the activated joining surfaces are brought into contact with each other, and are joined to each other at normal temperature. A load at the time of the joining may be, for example, from 100 N to 20,000 N. In one embodiment, when the surface activation with a neutralized beam is performed, an inert gas is introduced into a chamber, and a high voltage is applied from a DC power source to an electrode arranged in the chamber. With such configuration, an electric field generated between the electrode (positive electrode) and the chamber (negative electrode) causes electrons to move to generate atomic and ion beams derived from the inert gas. Among the beams that have reached a grid, the ion beam is neutralized at the grid, and hence a beam of neutral atoms is emitted from a high-speed atomic beam source. An atomic species for forming the beam is preferably an inert gas element (e.g., argon (Ar) or nitrogen (N)). At the time of the activation by beam irradiation, a voltage is, for example, from 0.5 kV to 2.0 kV, and a current is, for example, from 50 mA to 200 mA. The method for the direct joining is not limited thereto, and, for example, a surface activation method including using a fast atom beam (FAB) or an ion gun, an atomic diffusion method, or a plasma joining method may be applied.

The first metal thin film serving as the first joining portion and the second metal thin film serving as the second joining portion are directly joined as described above to be integrated with each other, to thereby form the second earth electrode 3. Thus, the laminate 11 having the configuration “inorganic material substrate 1/second earth electrode 3/support substrate 7” is obtained.

In addition, when the inorganic material substrate 1 and the support substrate 7 are joined to each other via the second earth electrode 3 and a joining portion, to prepare such laminate 11, the above-mentioned second earth electrode 3 is formed on the surface of the inorganic material substrate 1 described above by sputtering. Next, the above-mentioned joining portion is formed (more specifically, a Cr thin film having a thickness of 0.02 μm and an amorphous silicon layer having a thickness of 0.1 μm are sequentially formed) on the second earth electrode 3. After the film formation, the joining portion is subjected to planarization treatment by, for example, CMP polishing. In addition, a joining portion is also formed on the support substrate in the same manner as that described above as required.

Next, the inorganic material substrate and the support substrate are directly joined to each other in the same manner as that described above. Thus, the laminate 11 having the configuration “inorganic material substrate 1/second earth electrode 3/joining portion/support substrate 7” is obtained.

After that, the first via holes 8a and 8b collectively penetrating through the inorganic material substrate 1, the second earth electrode 3, and the support substrate 7 are formed by, for example, laser processing (more specifically, processing with a laser having a wavelength of 515 nm and a pulse width of 10 ps).

Next, underlying metal thin films are formed (more specifically, a Ti thin film having a thickness of 0.15 μm and a palladium thin film having a thickness of 0.04 μm are sequentially formed) on each of side wall portions in the first via holes 8a and 8b, the front surface of the inorganic material substrate 1, and the back surface of the support substrate 7 with, for example, an inductively coupled plasma (ICP) sputtering apparatus. After that, a surface metal thin film (e.g., a copper thin film having a thickness of 1.5 μm) is formed thereon by, for example, plating (more specifically, electroplating).

After that, a resist is applied to the metal thin film on the surface of the inorganic material substrate 1, and the resist is patterned by photolithography so that portions in which the gaps of the conductor layer 2 are to be formed may be exposed, and the other portions may be masked. After that, the conductor layer 2 (coplanar electrodes or microstrip electrodes) is formed by, for example, wet etching (more specifically, ferric chloride water).

Thus, the conductor layer is formed above the inorganic material substrate 1, the first vias 5 are formed in the first via holes 8, and the third earth electrode 4 is formed below the support substrate 7. Accordingly, the waveguide device can be smoothly produced as compared to the case where the conductor layer, the first vias, and the third earth electrode are separately formed. After that, the resist is removed. In the above-mentioned embodiment, the first vias 5 and the third earth electrode 4 are formed, and then the conductor layer 2 is formed by etching. However, the present invention is not limited thereto. The first vias 5, the third earth electrode 4, and the conductor layer 2 may be simultaneously formed.

Next, a method of producing the waveguide device 101 is described with reference to FIG. 7 to FIG. 9. In one embodiment, the method of producing the waveguide device 101 includes the steps of: preparing a laminate 12 including the inorganic material substrate 1, the second earth electrode 3, and the support substrate 7 in the stated order, the laminate 12 having the first via holes 8 collectively penetrating through the inorganic material substrate 1, the second earth electrode 3, and the support substrate 7, and the second via holes 9, which penetrate through the inorganic material substrate 1 and do not penetrate through the support substrate 7; and forming the first vias 5 in the first via holes 8, forming the second vias 6 in the second via holes 9, forming the third earth electrode 4 below the support substrate 7, and forming the conductor layer 2 above the inorganic material substrate 1.

The laminate 12 is prepared by directly joining the inorganic material substrate and the support substrate to each other as in the laminate 11.

After that, the first via holes 8 collectively penetrating through the inorganic material substrate 1, the second earth electrode 3, and the support substrate 7, and the second via holes 9, which penetrate through the inorganic material substrate 1 and do not penetrate through the support substrate 7, are formed by, for example, laser processing (more specifically, processing with a laser having a wavelength of 515 nm and a pulse width of 10 ps).

Next, underlying metal thin films are formed (more specifically, a Ti thin film having a thickness of 0.15 μm and a palladium thin film having a thickness of 0.04 μm are sequentially formed) on each of side wall portions in the first via holes 8 and the second via holes 9, the front surface of the inorganic material substrate 1, and the back surface of the support substrate 7 with, for example, an inductively coupled plasma (ICP) sputtering apparatus. After that, a surface metal thin film (e.g., a copper thin film having a thickness of 1.5 μm) is formed thereon by, for example, plating (more specifically, electroplating).

After that, the metal thin film on the surface of the inorganic material substrate 1 is masked and etched in the same manner as that described above to form the conductor layer 2 (coplanar electrodes or microstrip electrodes).

Thus, the conductor layer is formed above the inorganic material substrate 1, the first vias 5 are formed in the first via holes 8, the second vias 6 are formed in the second via holes 9, and the third earth electrode 4 is formed below the support substrate 7. Accordingly, the waveguide device can be smoothly produced as compared to the case where the conductor layer, the first vias, the second vias, and the third earth electrode are separately formed. After that, the resist is removed. In the above-mentioned embodiment, the first vias 5, the second vias 6, and the third earth electrode 4 are formed, and then the conductor layer 2 is formed by etching. However, the present invention is not limited thereto. The first vias 5, the second vias 6, the third earth electrode 4, and the conductor layer 2 may be simultaneously formed.

Thus, the waveguide device 101 can be produced.

The step of forming the first via holes and the second via holes after the formation of the laminate to prepare a laminate having the first via holes and the second via holes has been described in detail above. However, the step of preparing the laminate is not limited thereto. The following may be performed: after the second via holes have been formed in the inorganic material substrate in advance, holes are formed in each of the inorganic material substrate, the second earth electrode, and the support substrate; and the inorganic material substrate, the second earth electrode, and the support substrate are joined to each other so that the holes may communicate to each other to form the first via holes.

### EXAMPLES

The present invention is specifically described below by way of Reference Examples. However, the present invention is not limited by these Reference Examples.

### Reference Example 1

### 1-1. Production of Waveguide Device (Coplanar Line)

A quartz glass wafer (quartz glass substrate, inorganic material substrate) having a thickness of 0.5 mm was prepared, and a 0.2 μm amorphous silicon film was formed on the quartz glass wafer by sputtering. After the film formation, the amorphous silicon film was polished to be planarized. Here, the arithmetic average roughness of a □10 μm (10 μm square area; the same applies hereinafter) on the surface of the amorphous silicon film was measured with an atomic force microscope, and was found to be 0.2 nm.

In addition, a silicon wafer (support substrate) having a thickness of 525 μm was prepared. The arithmetic average roughness of the surface of a □10 μm on the surface of the silicon wafer was measured with an atomic force microscope, and was found to be 0.2 nm.

The amorphous silicon surface of the quartz glass wafer and the silicon wafer were directly joined to each other as described below. First, the quartz glass wafer and the silicon wafer were loaded into a vacuum chamber, and in a vacuum of the order of 10⁻⁶ Pa, both joining surfaces (the amorphous silicon surface of the quartz glass wafer and the surface of the silicon wafer) were irradiated with a high-speed Ar neutral atom beam (acceleration voltage: 1 kV, Ar flow rate: 60 sccm) for 70 seconds. After the irradiation, the quartz glass wafer and the silicon wafer were left to stand for 10 minutes to cool, and then the joining surfaces of the quartz glass wafer and the silicon wafer (beam-irradiated surfaces of the quartz glass wafer and the surface of the silicon wafer) were brought into contact with each other, followed by pressurization at 4.90 kN for 2 minutes to join the quartz glass wafer and the silicon wafer to each other. After the joining, polishing processing was performed until the thickness of the quartz glass wafer became 150 μm. Thus, a composite wafer was formed. In the resultant quartz glass/silicon composite substrate, no defect such as peeling was observed at the joining interface.

Then, a resist was applied to the surface (polished surface) of the quartz glass wafer on the opposite side to the silicon wafer, and patterning was performed by photolithography so as to expose portions for forming a coplanar electrode pattern. After that, on the upper surface of the quartz glass wafer exposed from the resist, a Cr film having a thickness of 50 nm and a Ni film having a thickness of 100 nm were formed by sputtering to form an underlying electrode. Further, copper was formed into a film on the underlying electrode by electroplating to form a coplanar electrode pattern. The length of a signal electrode in the waveguide direction was 10 mm.

Thus, a waveguide device including coplanar electrodes, an inorganic material substrate, and a support substrate was obtained.

### 1-2. Calculation of Propagation Loss

In order to measure the propagation loss of the waveguide device, three waveguide devices having signal electrode lengths of 30 mm, 40 mm, and 50 mm were produced in the same manner as in the foregoing.

Then, a RF signal generator was coupled to the input side of each of the waveguide devices with a probe, and an electromagnetic wave was coupled to a RF signal receiver placed for the probe on the output side of the waveguide device.

Then, a voltage was applied to the RF signal generator to cause the RF signal generator to transmit an electromagnetic wave having a frequency shown in Table 1. Thus, the electromagnetic wave was propagated to the coplanar line (waveguide device). The RF signal receiver measured the RF power of the electromagnetic wave output from the coplanar line. A propagation loss (dB/cm) was calculated from the measurement results of the three waveguide devices having different signal electrode lengths, and was evaluated by the following criteria. The results are shown in Table 1.
⊚ (excellent): less than 0.5 dB/cm
○ (good): 0.5 dB/cm or more and less than 1 dB/cm
Δ(acceptable): 1 dB/cm or more and less than 2 dB/cm
x (unacceptable): 2 dB/cm or more

### Reference Example 2

### 2-1. Production of Waveguide Device (Grounded Coplanar Line)

A quartz glass wafer (quartz glass substrate, inorganic material substrate) having a thickness of 0.5 mm was prepared, and a Cr film having a thickness of 50 nm and a Ni film having a thickness of 100 nm were formed on the quartz glass wafer by sputtering to form an underlying electrode. Further, copper was formed into a film on the underlying electrode by electroplating to form a second earth electrode. Then, a 0.2 μm amorphous silicon film was formed on the second earth electrode by sputtering. After the film formation, the amorphous silicon film was polished to be planarized. Here, the arithmetic average roughness of a □10 μm on the surface of the amorphous silicon film was measured with an atomic force microscope, and was found to be 0.2 nm.

In addition, a silicon wafer (support substrate) having a thickness of 525 μm was prepared. The arithmetic average roughness of the surface of a □10 μm on the surface of the silicon wafer was measured with an atomic force microscope, and was found to be 0.2 nm.

After that, the amorphous silicon surface formed on the ground electrode and the silicon wafer were directly joined to each other. The direct joining was carried out in the same manner as in Reference Example 1. In the resultant quartz glass/second earth electrode/silicon composite substrate, no defect such as peeling was observed at the joining interface.

Then, the quartz glass wafer was polished to a thickness of 150 μm.

Then, a coplanar electrode pattern was formed on the surface (polished surface) of the quartz glass wafer on the opposite side to the silicon wafer in the same manner as in Reference Example 1. The length of the signal electrode in the waveguide direction was 10 mm.

Thus, a waveguide device including coplanar electrodes, an inorganic material substrate, a second earth electrode, and a support substrate was obtained.

### 2-2. Calculation of Propagation Loss

In addition, in order to measure the propagation loss of the waveguide device, three waveguide devices having signal electrode lengths of 30 mm, 40 mm, and 50 mm were produced in the same manner as in the foregoing. Then, the RF power of an electromagnetic wave output from the coplanar line was measured with a RF signal receiver in the same manner as in Reference Example 1. The propagation loss of the waveguide device of Reference Example 2 was evaluated in the same manner as in Reference Example 1. The results are shown in Table 1.

### Reference Example 3

### 3-1. Production of Waveguide Device (Microstrip Line)

A quartz glass/second earth electrode/silicon composite substrate was obtained in the same manner as in Reference Example 2.

Then, a resist was applied to the surface (polished surface) of the quartz glass wafer on the opposite side to the silicon wafer, and patterning was performed by photolithography so as to expose portions for forming microstrip electrodes. After that, on the upper surface of the quartz glass wafer exposed from the resist, a Cr film having a thickness of 50 nm and a Ni film having a thickness of 100 nm were formed by sputtering to form an underlying electrode. Further, copper was formed into a film on the underlying electrode by electroplating to form microstrip electrodes. The length of each of the microstrip electrodes in the waveguide direction was 10 mm.

Thus, a waveguide device including microstrip electrodes, an inorganic material substrate, and a support substrate was obtained.

### 3-2. Calculation of Propagation Loss

In addition, in order to measure the propagation loss of the waveguide device, three waveguide devices having microstrip electrode lengths of 30 mm, 40 mm, and 50 mm were produced in the same manner as in the foregoing. Then, the RF power of an electromagnetic wave output from the coplanar line was measured with a RF signal receiver in the same manner as in Reference Example 1. The propagation loss of the waveguide device of Reference Example 3 was evaluated in the same manner as in Reference Example 1. The results are shown in Table 1.

### Reference Examples 4 to 6

Waveguide devices were produced in the same manner as in Reference Examples 1 to 3, respectively, except that the thickness of the quartz glass wafer (inorganic material substrate) after its polishing was changed to a value shown in Table 1.

The propagation loss of each of the resultant waveguide devices was calculated and evaluated in the same manner as in Reference Example 1. The results are shown in Table 1.

### Reference Example 7

A waveguide device was produced in the same manner as in Reference Example 1 except that: the quartz glass wafer serving as the inorganic material substrate was changed to a monocrystalline silicon wafer; and the thickness of the silicon wafer after its polishing was changed to a value shown in Table 1.

The propagation loss of the resultant waveguide device was calculated and evaluated in the same manner as in Reference Example 1. The results are shown in Table 1.

### Reference Example 8

A waveguide device was produced in the same manner as in Reference Example 1 except that: the quartz glass wafer serving as the inorganic material substrate was changed to a sapphire wafer; and the thickness of the sapphire wafer after its polishing was changed to a value shown in Table 1.

The propagation loss of the resultant waveguide device was calculated and evaluated in the same manner as in Reference Example 1. The results are shown in Table 1.

### Reference Example 9

A waveguide device was produced in the same manner as in Reference Example 1 except that: the quartz glass wafer serving as the inorganic material substrate was changed to a polycrystalline AlN wafer; and the thickness of the AlN wafer after its polishing was changed to a value shown in Table 1.

The propagation loss of the resultant waveguide device was calculated and evaluated in the same manner as in Reference Example 1. The results are shown in Table 1.

### Reference Example 10

A waveguide device was produced in the same manner as in Reference Example 1 except that the thickness of the quartz glass wafer (inorganic material substrate) after its polishing was changed to a value shown in Table 1.

The propagation loss of the resultant waveguide device was calculated and evaluated in the same manner as in Reference Example 1. The results are shown in Table 1.

### Reference Examples 11 to 14

Waveguide devices were each produced in the same manner as in Reference Example 3 except that the thickness of the quartz glass wafer (inorganic material substrate) after its polishing was changed to a value shown in Table 1.

The propagation loss of each of the resultant waveguide devices was calculated and evaluated in the same manner as in Reference Example 1. The results are shown in Table 1.

### Reference Example 15

A waveguide device was produced in the same manner as in Reference Example 2 except that the thickness of the quartz glass wafer after its polishing was changed to 300 μm.

The propagation loss of the resultant waveguide device was calculated and evaluated in the same manner as in Reference Example 1. The results are shown in Table 1.

### Reference Example 16

A waveguide device was produced in the same manner as in Reference Example 3 except that: a quartz glass wafer (quartz glass plate, inorganic material substrate) having a thickness of 2,100 μm was prepared; and the thickness of the quartz glass wafer after its polishing was changed to 2,000 μm.

The propagation loss of the resultant waveguide device was calculated and evaluated in the same manner as in Reference Example 1. The results are shown in Table 1.

TABLE 1

| | | | Reference | Reference | Reference | Reference | Reference | Reference |
|---|---|---|---|---|---|---|---|---|
| No. | | | Example 1 | Example 2 | Example 3 | Example 4 | Example 5 | Example 6 |
| Waveguide | Form | | Coplanar | Grounded | Microstrip | Coplanar | Grounded | Microstrip |
| device | | | line | coplanar | line | line | coplanar | line |
| | | | | line | | | line | |
| | Inorganic | Material | Quartz glass (amorphous) | | | Quartz glass (amorphous) | | |
| | material | Relative dielectric | 3.8 | | | 3.8 | | |
| | substrate | constant [—] | | | | | | |
| | | Dielectric loss | 0.0010 | | | 0.0010 | | |
| | | tangent [—] | | | | | | |
| | | Thickness [μm] | 150 | | | 80 | | |
| λ/a√ε | | λ [μm] | 1,000 | | | 1,000 | | |
| | | | (300 GHz) | | | (300 GHz) | | |
| | | a = 3 | 171 | | | 171 | | |
| | | a = 6 | 85 | | | 85 | | |
| Evaluation | Propagation | 30 GHz | ⊚ | ⊚ | ⊚ | ⊚ | ⊚ | ⊚ |
| | loss | 300 GHz | ◯ | ◯ | ◯ | ◯ | ⊚ | ⊚ |
| | | 1 THz | — | — | — | — | — | — |
| | | 20 THz | X | X | X | X | X | X |

| | | | | |
|---|---|---|---|---|
| | Reference | Reference | Reference | Reference |
| No. | Example 7 | Example 8 | Example 9 | Example 10 |

| | | | |
|---|---|---|---|
| Waveguide | Form | Coplanar line | Coplanar line |

| device | Inorganic | Material | Monocrystalline | Sapphire | Polycrystalline | Quartz glass |
|---|---|---|---|---|---|---|
| | material | | silicon | | AlN | (amorphous) |
| | substrate | Relative dielectric | 11.8 | 9.5 | 8.5 | 3.8 |
| | | constant [—] | | | | |
| | | Dielectric loss | 0.0016 | 0.0030 | 0.0015 | 0.0010 |
| | | tangent [—] | | | | |
| | | Thickness [μm] | 40 | 50 | 50 | 10 |
| λ/a√ε | | λ [μm] | 1,000 | | | 1,000 |
| | | | (300 GHz) | | | (300 GHz) |
| | | a = 3 | 97 | 108 | 114 | 171 |
| | | a = 6 | 49 | 54 | 57 | 85 |
| Evaluation | Propagation | 30 GHz | — | ∘ | — | ∘ |
| | loss | 300 GHz | ∘ | Δ | ∘ | ∘ |
| | | 1 THz | — | — | — | — |
| | | 20 THz | x | x | x | x |

| | | | Reference | Reference | Reference | Reference | Reference | Reference |
|---|---|---|---|---|---|---|---|---|
| No. | | | Example 11 | Example 12 | Example 13 | Example 14 | Example 15 | Example 16 |
| Waveguide | Form | | Microstrip line | | | | Grounded | Microstrip |
| device | | | | | | | coplanar | line |
| | | | | | | | line | |
| | Inorganic | Material | Quartz glass (amorphous) | | | | Quartz glass | |
| | material | | | | | | (amorphous) | |
| | substrate | Relative dielectric | 3.8 | | | | 3.8 | |
| | | constant [—] | | | | | | |
| | | Dielectric loss | 0.0010 | | | | 0.0010 | |
| | | tangent [—] | | | | | | |
| | | Thickness [μm] | 1,500 | 200 | 50 | 2.0 | 300 | 2,000 |
| λ/a√ε | | λ [μm] | 10,000 | 3,000 | 600 | 15 | 300 | 1,000 |
| | | | (30 GHz) | (100 GHz) | (500 GHz) | (20 THz) | (1 THz) | (300 GHz) |
| | | a = 3 | 1,710 | 513 | 103 | 2.56 | 51 | 171 |
| | | a = 6 | 855 | 256 | 51 | 1.28 | 25.6 | 85 |
| Evaluation | Propagation | 30 GHz | ◯ | ⊚ | ⊚ | ⊚ | Δ | X |
| | loss | 300 GHz | X | X | ⊚ | ⊚ | X | X |
| | | 1 THz | — | — | — | — | X | — |
| | | 20 THz | X | X | X | ◯ | — | X |

As is apparent from Table 1, it is found that in the case where the thickness of an inorganic material substrate satisfies the formula (1), a propagation loss when an electromagnetic wave having a high frequency of more than 30 GHz is guided is relatively small.

The waveguide device according to the embodiments of the present invention can be used in a wide range of fields, such as waveguides, next-generation high-speed communication, sensors, laser processing, and solar power generation, and in particular, can be suitably used as a waveguide for waves ranging from a millimeter wave to a terahertz wave. Such waveguide device can be used for, for example, an antenna, a band-pass filter, a coupler, a delay line (phase shifter), or an isolator.

What is claimed is:

1. A waveguide device capable of guiding an electromagnetic wave having a frequency of 30 GHz or more and 20 THz or less, comprising:
an inorganic material substrate;
a conductor layer arranged above the inorganic material substrate, the conductor layer including a signal electrode extending in a predetermined direction, and first earth electrodes each arranged in a direction intersecting the predetermined direction at a distance from the signal electrode;
a support substrate positioned on an opposite side to the conductor layer with respect to the inorganic material substrate;
a second earth electrode positioned between the inorganic material substrate and the support substrate; and
a third earth electrode positioned on an opposite side to the second earth electrode with respect to the support substrate,
wherein the first earth electrodes, the second earth electrode, and the third earth electrode are electrically connected to each other, and
wherein a thickness “t” of the inorganic material substrate satisfies the following formula (1):
$$t < \frac{λ}{a \sqrt{ε}} \qquad ( 1 )$$
where “t” represents the thickness of the inorganic material substrate, λ represents a wavelength of an electromagnetic wave guided by the waveguide device, ε represents a relative dielectric constant of the inorganic material substrate at 300 GHz, and “a” represents a numerical value of 3 or more.

2. The waveguide device according to claim 1, further comprising a first via, which is configured to electrically connect each of the first earth electrodes and the third earth electrode to each other, and is electrically connected to the second earth electrode.

3. The waveguide device according to claim 2, further comprising a first via hole in which the first via is arranged, the first via hole penetrating through the inorganic material substrate, the second earth electrode, and the support substrate.

4. The waveguide device according to claim 3, wherein the first via hole has a circular shape when viewed from a front surface (upper surface) direction of the inorganic material substrate, and has such a tapered shape that a diameter thereof becomes smaller as a distance thereof from the second earth electrode becomes shorter.

5. The waveguide device according to claim 3, wherein the first via hole has a circular shape when viewed from a front surface (upper surface) direction of the inorganic material substrate, and has such a tapered shape that a diameter thereof becomes larger as a distance thereof from the second earth electrode becomes shorter.

6. The waveguide device according to claim 2, further comprising a second via configured to electrically connect each of the first earth electrodes and the second earth electrode to each other,
wherein the waveguide device comprises the plurality of first vias, and
wherein the second via is arranged between the first vias adjacent to each other out of the plurality of first vias.

7. The waveguide device according to claim 6, further comprising a second via hole in which the second via is arranged, the second via hole penetrating through the inorganic material substrate and being free from penetrating through the support substrate.

8. The waveguide device according to claim 1, further comprising:
a second via configured to electrically connect each of the first earth electrodes and the second earth electrode to each other; and
a third via configured to electrically connect the second earth electrode and the third earth electrode to each other.

9. The waveguide device according to claim 1, wherein in the formula (1), “a” represents a numerical value of 6 or more.

10. The waveguide device according to claim 1, wherein the inorganic material substrate has a relative dielectric constant ε of 3.5 or more and 12.0 or less, and a dielectric loss tangent tanδ of 0.003 or less at 300 GHz.

11. The waveguide device according to claim 10, wherein the inorganic material substrate is a quartz glass substrate.

12. The waveguide device according to claim 1, wherein the conductor layer is coplanar electrodes.

13. The waveguide device according to claim 1, wherein the conductor layer and the second earth electrode are microstrip electrodes.

14. The waveguide device according to claim 12, wherein when the electromagnetic wave propagating in the waveguide device has a frequency of 30 GHz or more and 5 THz or less, the inorganic material substrate has a thickness of 10 μm or more.

15. A method of producing the waveguide device of claim 2, comprising the steps of:
preparing a laminate including the inorganic material substrate, the second earth electrode, and the support substrate in the stated order, the laminate having a first via hole collectively penetrating through the inorganic material substrate, the second earth electrode, and the support substrate; and
forming the first via in the first via hole, forming the third earth electrode below the support substrate, and forming the conductor layer above the inorganic material substrate.

16. A method of producing the waveguide device of claim 6, comprising the steps of:
preparing a laminate including the inorganic material substrate, the second earth electrode, and the support substrate in the stated order, the laminate having a first via hole collectively penetrating through the inorganic material substrate, the second earth electrode, and the support substrate, and a second via hole penetrating through the inorganic material substrate and being free from penetrating through the support substrate; and
forming the first via in the first via hole, forming the second via in the second via hole, forming the third earth electrode below the support substrate, and forming the conductor layer above the inorganic material substrate.
